(19) United States
(12) Patent Application Publication
(10) Pub. No.: US 2017/0318774 A1
(43) Pub. Date: Nov. 9, 2017

(54) Pet Container

(71) Applicant: Process4, Inc., Chagrin Falls, OH (US)

(72) Inventors: Curtis Taylor, Chagrin Falls, OH (US); Aaron Misener, Chagrin Falls, OH (US)

(21) Appl. No.: 15/586,415

(22) Filed: May 4, 2017

Related U.S. Application Data
(60) Provisional application No. 62/333,350, filed on May 9, 2016.

(51) Int. Cl. A01K 1/02; A01K 1/035; A01K 1/01; A01K 1/03; A01K 15/02

(52) U.S. Cl. CPC A01K 1/0245; A01K 15/02; A01K 1/0356; A01K 1/0107; A01K 1/034; A01K 1/0353

(57) ABSTRACT

A pet container comprising a container base and a container lid. The container lid includes a pivoting lid portion that can be used to teach pets to use the pet container.

The present invention claims priority on U.S. Provisional Application Ser. No. 62/333,350 filed May 9, 2016, which is incorporated herein by reference.

The present invention relates to pet containers, particularly to a pet container that includes a lid that allows access to the interior of the pet container, and more particularly to a pet container that includes a lid that partially or fully rotates to an open position to allow access to the interior of the pet container. The pet container of the present invention can be used as a training device to teach pets to use a kennel. The pet container of the present invention can be used as a pet kennel, pet carrier, pet litter box, etc.

### BACKGROUND ON THE INVENTION

Pet containers are known for a variety of uses in both home use and for travel. Generally, a pet container includes a bottom wall, one or more sidewalls, and optionally a lid. A door is usually provided on a sidewall to allow the pet to enter the pet container.

Existing pet containers suffer from several disadvantages: 1) many existing pet containers are formed of a steel or metal material that can have sharp edges which can be dangerous to both the pet and/or pet owner, 2) many existing pet containers are heavy and difficult to operate, and 3) many existing pet containers include a wire-formed cage door that uses a locking pin mechanism which can be difficult to use, can cause injury, and can occasionally fail.

Another problem with existing types of pet containers is that when a pet is introduced to a pet container, the pet tends to be unfamiliar with the pet container and frightened to use the pet container. This can result in an unpleasant experience for both the pet and the pet owner.

Non-limiting examples of prior art pet crates are illustrated in U.S. Pat. Nos. 6,196,161; 6,571,740; 7,712,437; 8,544,417; 8,613,260; US Publication Nos. 2012/0037083; 2012/0125265; 2012/0037083 and PCT Publication NO. WO 2008/124022, all of which are incorporated herein by reference.

### SUMMARY OF THE INVENTION

The present invention relates to a pet container that includes a lid that allows access to the interior of the pet container, and more particularly to a pet container that includes a lid that partially or fully rotates to an open position to allow access to the interior of the pet container. In accordance with one non-limiting embodiment of the present invention, the pet container includes a container base and a container lid that is optionally releasably secured to the container base, and which container base and container lid define an interior cavity in which a pet can reside. The container lid can be configured to be releasably secured to the container base. When the container lid is removed from the container base, the container base can function as a traditional pet bed or pet litter box; however, this is not required. When the container lid is connected to the container base, the pet container can be used as a pet kennel, pet crate, pet litter box, pet bed, pet cage, pet carrier, etc.

In one non-limiting aspect of the present invention, there is provided a pet container including a container base and a container lid defining an interior cavity. The shape and size of the container base and the container lid are non-limiting. In one non-limiting arrangement, the base of the container base is generally square or rectangular and has a sidewall extending partially or fully about and upwardly from the base of the container base. In one non-limiting embodiment, the sidewalls extend upwardly about 0.5-12 inches (and all values and ranges therebetween) above the top surface of the container base, and typically about 1-8 inches, and more typically about 2-6 inches. In another non-limiting arrangement, the container lid can be generally hemispherical; however, the container lid can have other shapes. The interior cavity of the pet container formed by the container base and the container lid typically has a size of about 2-100 ft³ (and all values and ranges therebetween), more typically a size of about 3-50 ft³, and still more typically a size of about 3-40 ft³. As such, the pet container of the present invention can be configured to accommodate pets of various sizes (e.g., puppies, young dogs, old dogs, kittens, cats, etc.). Generally, the volume of the container lid is greater than the volume of the container base. Generally, the weight of the pet container of the present invention is about 0.5 lbs.-100 lbs. (and all values and ranges therebetween), typically about 0.5 lbs.-60 lbs., and more typically about 1 lbs.-40 lbs. Generally, the pet container is a portable pet container.

In another and/or alternative non-limiting aspect of the present invention, the pet container includes a container base with an upwardly-facing open end. The size, shape, configuration, and materials of the container base are non-limiting. In one non-limiting configuration, the container base has a generally rectangular shape and the cross-sectional shape of the container base is generally rectangular; however, other or alternative shapes and cross-sectional shapes can be used (e.g., circular, oval, square, trapezoidal, polygonal, etc.). The cross-sectional shape of the container base can increase and then decrease along the length and/or width dimension of the container base; however, this is not required. As can be appreciated, the cross-sectional shape of the container base can be generally constant along the length of the container. Generally, the container base includes at least one sidewall, typically at least two sidewalls, more typically at least three sidewalls, and even more typically four sidewalls; however, this is not required. As can be appreciated, the container base can include more than four sidewalls or less than four sidewalls depending on the configuration and look desired and/or needed for the container base. The one or more sidewalls can form an interior and external sidewall surface.

In yet another and/or alternative non-limiting aspect of the present invention, the container base has a generally planar bottom wall and one or more sidewalls that extend upwardly, approximately perpendicularly (e.g., 85-95°) from the base or bottom wall. The one of more sidewalls can be continuous through the corners and the bottom wall; however, this is not required. In another and/or alternative non-limiting aspect of the present invention, the one or more sidewalls can be bowed radially outward such that the entire perimeter of the container base is curved; however, this is not required. In yet another and/or alternative non-limiting aspect of the present invention, the one or more sidewalls taper outwardly from each other when moving away from the bottom wall such that the area of the top, open end of the container base is larger than the area of the bottom wall; however, this is not required. As such, the bottom wall and one or more upwardly extending sidewalls define a container base interior cavity of the pet container.

In still yet another and/or alternative non-limiting aspect of the present invention, the top edge of the one or more sidewalls that define the open end of the container base can include a coupling edge; however, this is not required. The coupling edge (when used) can be used to receive a corresponding coupling edge of the container lid; however, this is not required. In another and/or alternative non-limiting aspect of the present invention, the interior and/or external surface of the one or more container base sidewalls optionally includes latching members for the purpose of releasably securing the container lid to the container base; however, this is not required.

In another and/or alternative non-limiting aspect of the present invention, the container base can include a mesh and/or plate structure at or near one or more edges of the container base. In one non-limiting configuration, a mesh and/or plate structure can be provided at the front edge of the container base so as to prevent materials inside the pet container from being tracked outside of the pet container; however, this is not required.

In another and/or alternative non-limiting aspect of the present invention, the pet container can include a container lid comprising a stationary lid portion and a pivoting lid portion; however, this is not required. The container lid can include one or more movable parts; however, this is not required. The size, shape, configuration, and materials of the one or more components of the container lid are non-limiting. In one non-limiting configuration, the pivoting lid portion of the container lid has a size larger than the size of the stationary lid portion; however, this is not required. In one non-limiting configuration, the container lid has a generally hemispherical shape and the cross-sectional shape of the container lid is generally semicircular; however, other or alternative shapes and cross-sectional shapes can be used (e.g., square, rectangular, oval, triangular, trapezoidal, polygonal, etc.). The container lid is configured to be positionable on the container base; however, this is not required. As such, the container lid is configured to partially or fully cover the container base. At least a portion of the container lid is configured to permit access to the interior cavity of the pet container; however, this is not required. In an open position, the pivoting lid portion of the container lid defines a shaped opening which is sized to allow a pet to pass readily through the shaped opening into and out of the internal cavity of the pet container; however, this is not required.

In another and/or alternative non-limiting aspect of the present invention, the container lid can include a stationary lid portion. The stationary lid portion of the container top can include spaced apart sidewalls and a top wall along the peripheral edge of the sidewalls. The two sidewalls and the top wall can be formed in a one-piece construction; however, this is not required. In one non-limiting configuration, one sidewall is formed marginally continuous with one portion of the top wall, and the second sidewall is formed marginally continuous with the other portion of the top wall; however, this is not required. As such, when the pet container is disassembled, the pet container lid required less storage space. As can be appreciated, the container lid can be formed of more than two pieces. During assembly, the first and second portion of the stationary lid portion of the container lid can be releasably connected together by one or more screws or bolts; however, other or alternative connection arrangements can be used (e.g., glue, snap connection, tongue and groove connection, etc.). The two sidewalls can be spaced about equal to, greater than, or less than the width of the container base. When the stationary lid portion is positioned on the container base, the pivoting lid can be designed to fit between the inner surface of the two sidewalls of the stationary lid portion. Generally, the fit is with slight clearance; however, this is not required. As such, the pivoting lid portion of the container lid can pass at least partially into the stationary lid portion through the opening. The two sidewalls of the stationary lid portion can include a pivot point and/or connection arrangement for the pivoting lid portion; however, this is not required. The type of pivot and/or connection arrangement is non-limiting and can include a pivot pin, rotation axle, etc. As can be appreciated, the pivoting lid portion can be formed of a single piece or by multiple pieces. When the pivoting lid portion is formed by multiple pieces, the multiple pieces can be connected together in the same or similar manner as describe above with regard to the stationary lid portion; however, this is not required.

In another and/or alternative non-limiting aspect of the present invention, the stationary lid portion of the container lid can be rigidly connected to the container base; however, this is not required. As can be appreciated, the stationary lid portion of the container lid can be releasably and/or pivotally connected to the container base; however, this is not required. In one non-limiting configuration, the stationary lid portion of the container lid is non-releasably connected to the container base and non-releasably connected to the pivoting lid portion of the container lid; however, this is not required. Generally, the two bottom edges of the stationary lid portion of the sidewalls correspond in shape and size to the coupling edge of the container base; however, this is not required. The coupling edge can optionally include a coupling lip around the perimeter of the edge of the stationary lid portion; however, this is not required. The coupling lip (when used) can be designed to partially or fully engage with a coupling lip about the coupling edge of the container base; however, this is not required. In another and/or alternative non-limiting configuration, the stationary lid portion of the container lid can be releasably secured to the container base. The type of releasable connection arrangement is non-limiting (e.g., latch, hook and loop fastener, pin connection, slot connection, magnetic connection, etc.). In one non-limiting arrangement, one or more latching mechanisms are used to releasably connect the stationary lid portion of the container lid to the container base; however, this is not required. The type of latching mechanism (when used) is non-limiting. When one or more latching mechanisms are used, the one or more latching mechanisms can be the same or different.

In another and/or alternative non-limiting aspect of the present invention, the stationary lid portion of the container lid can include one or more openings and/or apertures such that fresh air can circulate through the interior cavity of the pet container; however, this is not required. The size, shape, configuration, and/or number of the one or more openings and/or apertures are non-limiting. In one non-limiting configuration, the two sidewalls include at least one aperture, more typically at least two apertures, still more typically at least three apertures; however, this is not required. The top wall of the stationary lid portion can be absent openings and/or apertures; however, this is not required. The size of each aperture is non-limiting. The size of the apertures can be the same or different. One or more apertures can optionally include a grill or mesh material to inhibit or prevent an animal from passing though the one or more apertures. Also or alternatively, the size of one or more apertures can optionally be selected to inhibit or prevent an animal from passing though the one or more apertures.

In another and/or alternative non-limiting aspect of the present invention, the stationary lid portion of the container lid optionally includes one or more ridges, grooves, or other type of surface structure on the external surface of the top wall; however, this is not required. The size, shape, configuration, and number of surface structures are non-limiting. In one non-limiting configuration, the external surface of the top wall of the stationary lid portion includes one or more grooves; however, this is not required. The one or more grooves can be used as surface structures to facilitate bolting the two halves of the stationary lid portion together; however, this is not required. As will be discussed later, the one or more surface structures (when used) can be configured to facilitate the incremental opening of the container lid.

In another and/or alternative non-limiting aspect of the present invention, the container lid includes a pivoting lid portion. The pivoting lid portion of the container top can include two parallel spaced sidewalls, a front wall, and a top wall. The size, shape, and configuration of the pivoting lid portion can be the similar or different than the stationary lid portion. In one non-limiting configuration, the two sidewalls, the front wall, and the top wall are formed in a one-piece construction; however, this is not required. The two sidewalls are generally spaced about equal to or less than the width of the container base, such that the pivoting lid portion is positioned on the container base; however, this is not required. The pivoting lid portion can be configured to at least partially fit through the opening of the stationary lid portion when moved between the open and closed position; however, this is not required. The space between the two sidewalls, the front wall, and the top wall of the pivoting lid portion is open; however, this not required. The two sidewalls of the pivoting lid portion can include a pivot and/or connection arrangement; however, this is not required. The pivot and/or connection arrangement of the pivoting lid portion can be designed to correspond to the pivot and/or connection arrangement of the stationary lid portion; however, this is not required.

In another and/or alternative non-limiting aspect of the present invention, the pivoting lid portion of the container lid can be pivotally connected to the container base and/or the stationary lid portion of the container lid. In one non-limiting configuration, the pivoting lid portion of the container lid is pivotally connected to the stationary lid portion of the container lid; however, this is not required. Generally, the bottom edges of the two sidewalls, the front wall and the top wall of the pivoting lid portion correspond in shape and size to the coupling edge of the container base; however, this is not required. The coupling edge can optionally include a coupling lip around the perimeter of the edge of the pivoting lid portion; however, this is not required. The coupling lip (when used) can be designed to partially or fully engage with a coupling lip about the coupling edge of the container base; however, this is not required. In another and/or alternative non-limiting configuration, the pivoting lid portion of the container lid can be releasably secured to the container base by one or more latching mechanisms; however, this is not required. The type of latching mechanism (when used) is non-limiting. When one or more latching mechanisms are used, the one or more latching mechanisms can be the same or different.

In another and/or alternative non-limiting aspect of the present invention, the pivoting lid portion of the container lid can include one or more openings and/or apertures such that fresh air can circulate through the interior cavity of the pet container. The size, shape, configuration, and number of the one or more openings and/or apertures are non-limiting. In one non-limiting configuration, an opening is provided in each of the two sidewalls and in the front wall of the pivoting lid portion; however, this is not required. The one or more openings and/or apertures can optionally be sized to inhibit or prevent a pet from exiting the pet container through said openings; however, this is not required. One or more grates, rods, meshes and/or bar structures can be provided within one or more openings for the purpose of inhibiting or preventing a pet from exiting the pet container through said openings; however, this is not required. The grate structure (when used) can be pivotally connected to the wall of the pivoting lid portion; however, this is not required. As such, the grate structure (when used) can be opened and closed as a door to the pet container.

In another and/or alternative non-limiting configuration of the present invention, the walls of the pivoting lid portion can be absent openings and/or apertures; however, this is not required. In still another and/or alternative non-limiting configuration of the present invention, the front wall of the pivoting lid portion can include a door; however, this is not required. The door (when used) is not limited in shape, size, or configuration. In one non-limiting configuration, the door can be designed to be rotatable about a rod so as to provide access to the internal cavity of the pet container as the pet desires; however, this is not required.

In another and/or alternative non-limiting aspect of the present invention, the pivoting lid portion is pivotally connected to the container base and/or the stationary lid portion of the container lid; however, this is not required. In operation, the pivoting lid portion of the container lid is operable to move between an open and closed position. In one non-limiting configuration, the pivoting lid portion pivots about a pivot point and sits over the stationary lid portion of the container lid; however, this is not required. The pivot and/or connection means is non-limiting (e.g., pivot pin, bearing, axle, etc.). The pivoting lid portion of the container lid can be designed to pivot between an open and closed position about the pivot point when the pivoting lid portion and the stationary lid portion are positioned on the container base. Generally, the pivoting lid portion of the container lid is designed so that it cannot pivot 360° about the pivot point when the pivoting lid portion and the stationary lid portion are positioned on the container base. In one non-limiting embodiment, the pivoting lid portion of the container lid is designed to pivot 0-150° (and all values and ranges therebetween) about the pivot point when the pivoting lid portion and the stationary lid portion are positioned on the container base. In one non-limiting embodiment, the pivoting lid portion of the container lid is designed to pivot 0-120° about the pivot point when the pivoting lid portion and the stationary lid portion are positioned on the container base. In one non-limiting embodiment, the pivoting lid portion of the container lid is designed to pivot 0-110° about the pivot point when the pivoting lid portion and the stationary lid portion are positioned on the container base. In one non-limiting embodiment, the pivoting lid portion of the container lid is designed to pivot 0-90° about the pivot point when the pivoting lid portion and the stationary lid portion are positioned on the container base. In one non-limiting embodiment, the pivoting lid portion of the container lid is designed to pivot 0-85° about the pivot point when the pivoting lid portion and the stationary lid portion are positioned on the container base. In an open position, 1) an internal surface of one sidewall of the pivoting lid portion is adjacent to the external surface of one sidewall of the stationary lid portion, 2) an internal surface of the other sidewall of the pivoting lid portion is adjacent to the external surface of the other sidewall of the stationary lid portion, 3) the internal surface of the front wall of the pivoting lid portion is adjacent to the external surface of a top portion of the arcuate top wall of the stationary lid portion, and 4) the internal surface of the top wall of the pivoting lid portion is adjacent to the external surface of the bottom portion of the arcuate top wall of the stationary lid portion; however, this is not required.

In another and/or alternative non-limiting aspect of the present invention, the container lid of the pet container of the present invention can include one or more opening actuators such as, but not limited to, tabs, knobs, latches, hooks, levers, buttons, etc. In one non-limiting configuration, an opening actuator is positionable at or near the rear edge of the top wall of the pivoting lid portion of the container lid; however, this is not required. In another and/or alternative non-limiting configuration, the opening actuator is an ergonomic quick release button; however, this is not required. A quick release button (when used) can be pivotable about a pivot member provided on the top wall of the pivoting lid portion; however, this is not required. As such, a first end of the button can include a hook and/or flange designed to frictionally engage with the front edge of the stationary lid portion when the pivoting member is in a closed position, thereby preventing the pivoting lid portion from pivoting and moving to an open position. When the second end of the button is depressed, the first end of the button raises upwards so as to disengage the frictional engagement between the hook and/or flange and the front edge of the stationary lid portion. As can be appreciated, other or alternative arrangements could be used.

In another and/or alternative non-limiting aspect of the present invention, the pet container includes one or more hinge assemblies to facilitate movement of the container lid between the open and closed positions. The one or more hinge assemblies (when used) can include one or more struts (e.g., mechanical struts, gas struts, hydraulic struts, etc.) so as to prevent the pivoting lid portion of the container lid from closing with excessive force; however, this is not required. In one non-limiting configuration, gas struts are used; however, this is not required. The one or more hinge assemblies can also or alternatively optionally include one or more spring systems (e.g., mechanical springs, etc.) for the purpose of counterbalancing the weight of the pivoting lid portion, or to bias the pivoting lid portion of the container lid in a fully closed, partially closed, partially open, or fully open position; however, this is not required. In one non-limiting configuration, a mechanical spring assembly is used to bias the pivoting lid portion of the container lid in an open position; however, this is not required. As such, when the opening actuator is actuated, the pivoting lid portion of the container lid moves partially or fully to the open position, thereby allowing a pet to enter the pet container; however, this is not required.

In one non-limiting means of operation, the pivoting lid portion of the container lid is biased in an open position by one or more springs and the external surface of the top wall of the stationary lid portion of the container lid includes two surface structures. When the opening actuator is actuated, the pivoting lid portion is rotated by the one or more springs about a pivot point. As the pivoting lid portion rotates towards the fully open position, the flange of the depressible button can optionally be designed to engage with a first surface groove on the external surface of the top wall of the stationary lid portion. The engagement between the flange and the first surface groove can be designed to stop the opening of the pivoting lid portion at a point wherein the pivoting lid portion has moved from the closed positioned toward the fully open position and has pivoted about 10-50° (and all values and ranges therebetween) about the pivot point, and typically has pivoted about 15-30° about the pivot point. If it is desired to open the pet container further, the opening actuator can be again depressed, thereby releasing the flange of the depressible button from the first surface groove of the stationary lid portion. As the pivoting lid portion continues to rotate towards the fully open position, the flange of the depressible button can optionally engage with a second surface groove on the external surface of the top wall of the stationary lid portion. The engagement between the flange and the second surface groove can be designed to stop the opening of the pivoting lid portion at a point wherein the pivoting lid portion has moved toward the fully open position and has pivoted about 30-90° (and all values and ranges therebetween) about the pivot point, and typically has pivoted about 40-60° about the pivot point. If it is desired to fully open the pet container, the opening actuator can again be depressed, thereby releasing the flange of the depressible button from the second surface groove of the stationary lid portion. As the pivoting lid portion continues to rotate towards the fully open position, the flange of the depressible button can be designed to engage with the bottom edge of the stationary lid portion of the container lid. The engagement between the flange and the surface groove that stops the opening of the container can be designed to stop the opening of the pivoting lid portion at a point wherein the pivoting lid portion has moved toward the fully open position and has pivoted about 50-150° (and all values and ranges therebetween) about the pivot point, and typically has pivoted about 80-120° about the pivot point. As can be appreciated, the external surface of the top wall of the stationary lid portion can include more than two or less than two surface structures for the purpose of adjusting the degree to which the pet container opens; however, this is not required. As can also be appreciated, the top wall of the stationary lid portion can be absent a surface structure. In such a configuration, the pivoting lid portion is operable between a closed position (e.g., a rotation of 0° of the pivoting lid portion about the pivot point when in the closed position) to a fully open position (e.g., a rotation of about 80-120° of the pivoting lid portion about the pivot point). As can also be appreciated, the stationary lid portion can optionally be designed to rotate about the pivot point; however, this is not required.

In another and/or alternative non-limiting aspect of the present invention, the pet container optionally includes a locking mechanism. In one non-limiting configuration, the locking mechanism can be integrated with the opening actuator; however, this is not required. As can be appreciated, the locking mechanism can be located at any edge of the container base and/or container base and/or container lid. The type of locking mechanism used is non-limiting. In one non-limiting configuration, the locking mechanism optionally includes a key and keyhole configuration such that a key can be used to lock the pet container in an open and/or closed position.

In another and/or alternative non-limiting aspect of the present invention, the container lid optionally includes a handle. The size, shape, configuration, and material of the handle are non-limiting. The handle can optionally be connected to the container lid of the pet container for the purpose of facilitating movement of the pet container. The profile of the handle (when used) is generally selected to be a low profile; however, this is not required. The low profile of the handle (when used) enables the handle to be tucked away and/or hidden when the container lid is in the open position; however, this is not required. In one non-limiting configuration, the handle is designed to be pivotally connected to the container lid; however, this is not required. In another and/or alternative non-limiting configuration, the handle is designed to be pivotally and/or rotatabbly connected to the external surface of the stationary lid portion of the container lid; however, this is not required. In a tucked away position (i.e., as the pivoting lid portion of the container lid is rotated over the stationary lid portion of the container lid), the handle is moved into a cavity or recess formed in the external surface of the stationary lid portion of the container lid; however, this is not required. In such a configuration, the pivoting lid portion of the container lid can be freely rotated between an open and closed position without interference by the handle.

In another and/or alternative non-limiting aspect of the present invention, the one or more components of the pet container of the present invention are formed of a lightweight and durable material. As can be appreciated, the one or more components of the pet container can be formed of a number of different materials (e.g., plastic or polymer material, rubber material, composite material, ceramic, wood, metal, etc.). In one non-limiting configuration, at least a majority of the pet container is formed of a plastic material; however, this is not required. However, it can be appreciated that the pet container can be formed of other or additional materials (e.g., a high-density polyethylene (HDPE) plastic, a low-density polyethylene (LDPE) plastic, rubber material, polyvinyl chloride (PVC), various types of resins, various types of resin epoxides, polyester, polypropylene, polyurethane, polyacrylate, and copolymers thereof, etc.). One non-limiting advantage of using a plastic material in the formation of the pet container is that the plastic material (when used) is a generally inexpensive material in manufacturing and is typically easy to clean. The plastic material (when used) can be opaque, translucent, or transparent. The translucent materials (when used) can facilitate the viewing of the pet in the pet container; however, this is not required. The opaque materials (when used) can be used for the purpose of preventing viewing of the pet in the pet container, thereby providing a degree of privacy to the pet in the pet container; however, this is not required.

In another and/or alternative non-limiting aspect of the present invention, the thickness of the material used to form the one or more components of the pet container of the present invention can be selected to have the desired strength and durability properties of the pet container. In one non-limiting embodiment, the thickness of a plastic material is in the range of about 0.5 mm to about 1.5 mm, and typically about 1.0 mm; however, other thicknesses can be used.

In operation, the pet container can be used as a pet kennel or pet cage. A pet owner can place a pet into the pet container by 1) actuating the opening actuator, thereby allowing the pivoting lid portion of the container lid to rotate partially or fully to the fully open position, 2) placing the pet into the internal cavity of the pet container, 3) pushing down the pivoting lid portion of the container lid such that the pivoting lid portion rotates back toward the fully closed position, and 4) continuing to push the pivoting lid portion down to the fully closed position, thereby allowing the opening actuator and/or locking mechanism to engage and maintain the pivoting lid portion in the fully closed position.

In operation, the pet container can also be used as a trainer to encourage a pet to use the pet container as a pet cage and/or pet kennel. One non-limiting method for using the pet container of the present invention as a pet container trainer can comprise the steps of 1) providing the pet container with the container base without the container top such that the pet trusts and finds comfort in the container base of the pet container. Thereafter, 2) positioning the container lid on top of the container base in a fully open position until the pet becomes comfortable with the container base having a container top. Thereafter, 3) rotating the pivoting lid portion of the container lid to a slightly more closed position until the pet becomes comfortable with the container base having a container top in a partially closed position. Thereafter, 4) further rotating the pivoting lid portion of the container lid to a slightly more closed position until the pet becomes comfortable with the container base having a container top in more partially closed position. Thereafter, 5) rotating the pivoting lid portion of the container lid to a fully closed position. As such, over time, the pivoting lid portion of the container lid can be incrementally lowered towards a closed position to transition the pet to feel more comfortable with being inside the pet container as the container lid is gradually lowered and finally fully closed. As can be appreciated, one or all of the partial closing steps can be eliminated.

One non-limiting object of the present invention is the provision of a pet container that can be easily and conveniently disassembled and/or broken down for storage.

Another and/or alternative non-limiting object of the present invention is the provision of a pet container that can be easily and conveniently open and/or closed so as to allow access to the internal cavity of the pet container.

Still another and/or alternative non-limiting object of the present invention is the provision of a pet container including soft rounded corners and/or edges.

Still yet another and/or alternative non-limiting object of the present invention is the provision of a pet container comprising a simple and streamlined form.

Another and/or alternative non-limiting object of the present invention is the provision of a pet container which is functionally and aesthetically designed.

Still another and/or alternative non-limiting object of the present invention is the provision of a pet container formed of lightweight, long-lasting, and durable materials.

Still yet another and/or alternative non-limiting object of the present invention is the provision of a pet container which is quiet during operation.

Another and/or alternative non-limiting object of the present invention is the provision of a pet container that can be easily and conveniently operated without bending over.

Still another and/or alternative non-limiting object of the present invention is the provision of a pet container wherein a front pivoting lid portion of the container lid rotates up and partially or fully covers the stationary lid portion of the container lid.

Still yet another and/or alternative non-limiting object of the present invention is the provision of a pet container which can be easily and conveniently transformed between a pet bed and a pet crate.

Another and/or alternative non-limiting object of the present invention is the provision of a pet container which can be used in a home, office, pet center, doggie daycare, training camps, apartments, bedrooms, etc.

Another and/or alternative non-limiting object of the preset invention is the provision of a pet container which can be used as a kennel and/or crate trainer.

These and other objects and advantages will become apparent from the following description taken together with the accompanying drawings.

### BRIEF DESCRIPTION OF THE DRAWINGS

Reference may now be made to the drawings, which illustrate various embodiments that the invention may take in physical form and in certain parts and arrangements of parts wherein:

FIG. 1 is a front elevation view of a non-limiting pet container in accordance with the present invention;

FIG. 2 is a rear elevation view of the pet container of FIG. 1;

FIG. 3 is a front elevation partially exploded view of the pet container of FIG. 1;

FIG. 4 is a front elevation view of the pet container of FIG. 1 wherein the container lid is in a fully open position;

FIG. 5 is a front elevation partial-exploded view of the pet container of FIG. 4 showing removed pet bowls and containers that can be optionally positioned in the pet container;

FIG. 6 is an enlarged elevation view of an opening actuator of the pet container of FIG. 1;

FIG. 7 is a side view of the pet container of FIG. 1;

FIG. 8 is a side cross-section view of a mechanical strut of the pet container of area B of FIG. 7;

FIG. 9 is an enlarged top elevation view of the handle of the pet container of FIG. 1 in an upright position;

FIG. 9 is an enlarged top elevation view of a handle in an upright position in accordance with another pet container of the present invention;

FIG. 10 is an enlarged top elevation view of a handle in an upright position in accordance with another pet container of the present invention;

FIG. 11 is an enlarged top elevation view of the handle of FIG. 10 wherein the handle is in a tucked away position;

FIG. 12 an enlarged a top elevation view of the handle of FIG. 11 wherein the container lid is in an open position;

FIG. 13 is an enlarged exploded side-view of the hinge assembly of the pet container of FIG. 1; and,

FIG. 14 is a top elevation view of the pet container of FIG. 1 in a fully disassembled position.

### DETAILED DESCRIPTION OF A NON-LIMITING EMBODIMENTS

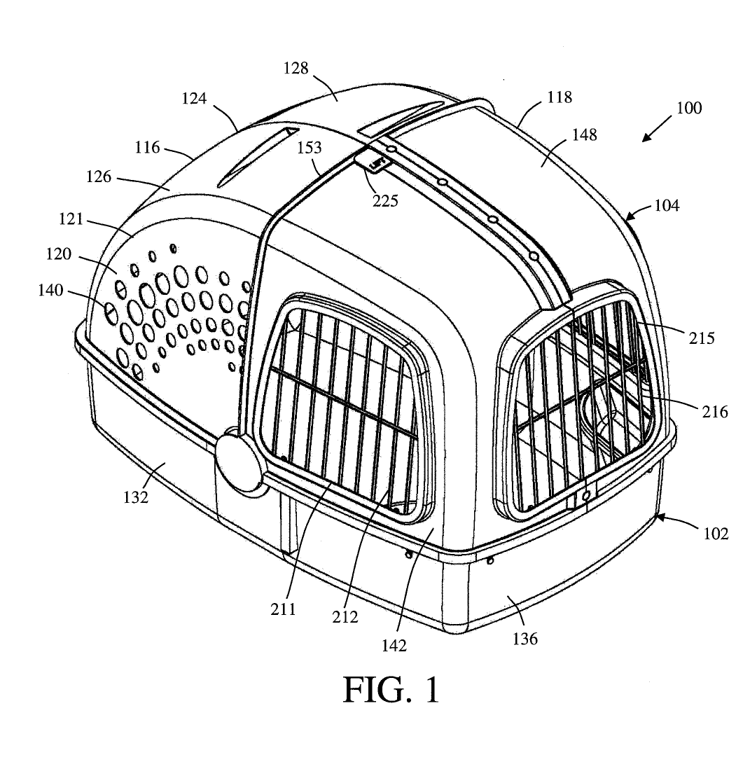

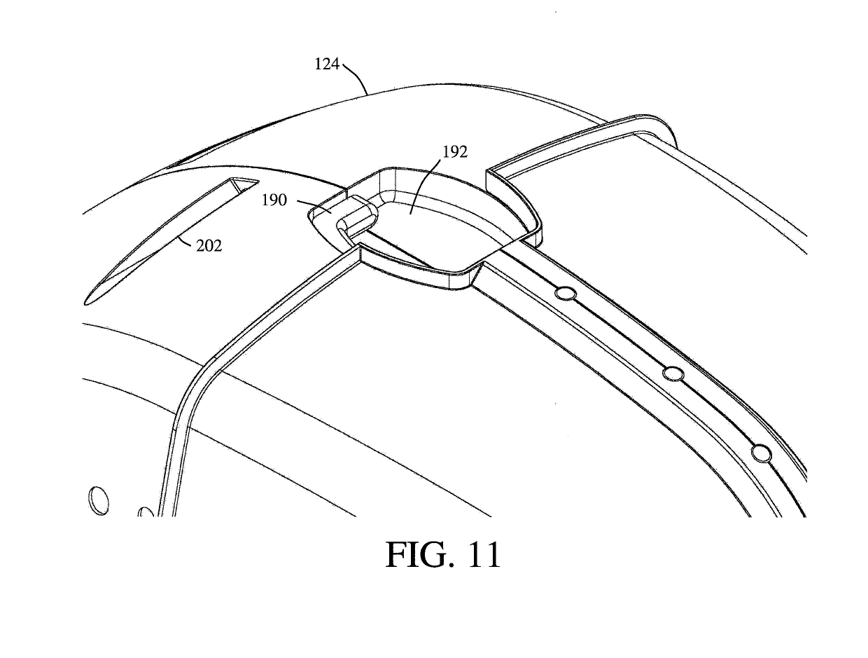

Referring now to the drawings, wherein the showings are for the purpose of illustrating at least one non-limiting embodiment of the invention only and not for the purpose of limiting the invention, FIGS. 1-14 illustrate various non-limiting pet containers in accordance with the present invention.

Referring now to FIGS. 1-8, there is illustrated a pet container 100 comprising a container base 102 and a container lid 104. The container lid 104 is illustrated as being connected to the container base 102, thereby defining an interior cavity 106 in which a pet (not shown) can reside. The container lid 104 can be releasably secured and/or removable from the container base 102; however, this is not required. Thus, the pet container 100 of the present invention has a unique advantage in providing two conformations and uses within a single product: 1) when the container lid 104 is removed from the container base 102, the container base 102 can function as a traditional pet bed or litter box, and 2) when the container lid 104 is releasably secured to the container base 102, the pet container 100 can be used as a pet kennel, pet crate, litter box, pet bed, pet cage, pet carrier, etc.

As best illustrated in FIGS. 1-8, the container base 102 comprises a base wall 130, two sidewalls 132, 134, a front wall 136 and a rear wall 138. The base wall 130 is illustrated as being generally rectangular in shape and can have a generally flat upper surface; however, this is not required. The two sidewalls 132, 134, front wall 136 and rear wall 138 extending upwardly from the top surface of the base wall, approximately perpendicularly (e.g., 85-95°) and are connected at or near the peripheral edges of the base wall. The two sidewalls 132, 134, front wall 136 and rear wall 138 are illustrated as being continuous through the corners. Furthermore, the two sidewalls 132, 134, front wall 136 and rear wall 138 are illustrated as being continuous with the base wall 130. Generally, the container base is formed of a single material. For example, the container base can be formed of a molded or blow-formed piece of plastic material; however, this is not required.

The two sidewalls 132, 134, the front wall 136 and rear wall 138 are illustrated as being bowed radially outward such that the perimeter of the container base 102 is curved; however, this is not required. Additionally, the two sidewalls 132, 134, front wall 136 and rear wall 138 are illustrated as tapering slightly outwardly from each other when moving upwardly from the base wall 130. As such, the area of the top, open end of the container base 102 is generally larger than the area of the base wall 130. The base wall 130, two sidewalls 132, 134, front wall 136 and rear wall 138 define at least a portion of the interior cavity 106 of the pet container 100. The top edge of the two sidewalls 132, 134, front wall 136 and rear wall 138 forms a coupling edge 103 of the container base 102.

The container lid 104 is illustrated as having a generally hemispherical shape and as being positionable on the container base 102. Thus, the container lid 104 is configured to partially or fully cover the base 102. At least a portion of the container lid 104 is configured to permit access to the interior cavity 106 of the pet container 100.

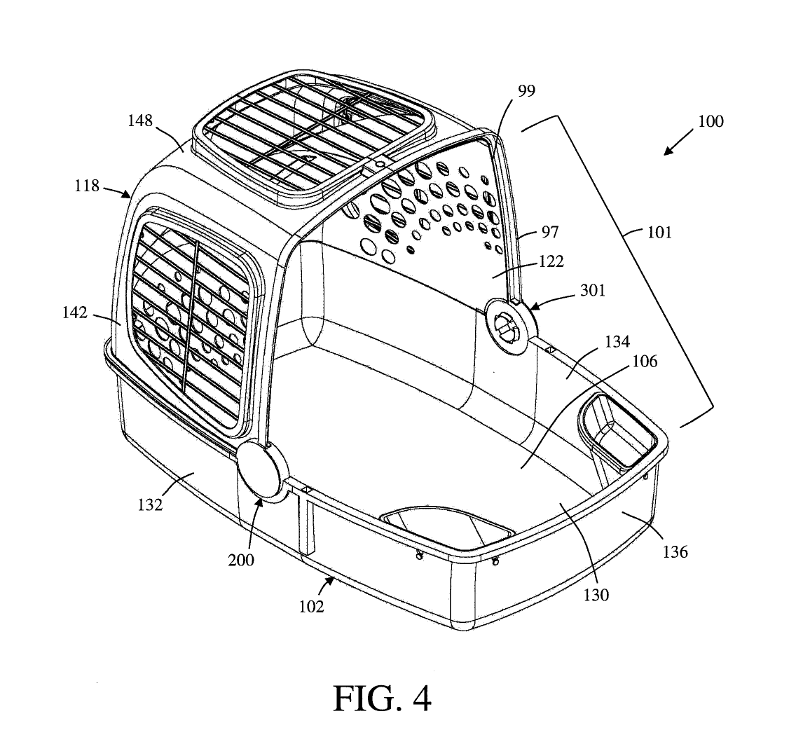

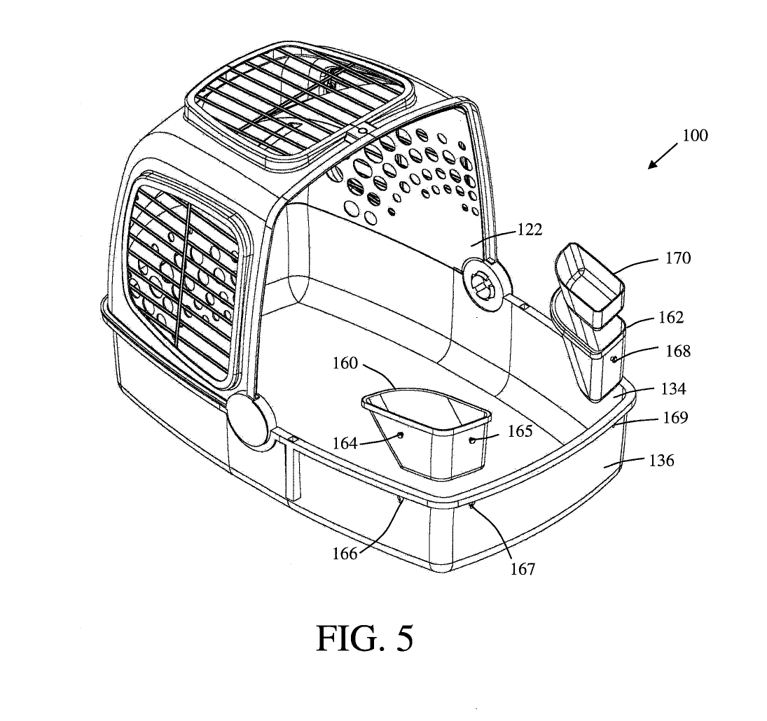

The container lid 104 of pet container 100 further comprises a stationary lid portion 116 and a pivoting lid portion 118. In an open position (see FIGS. 4-5), the stationary lid portion 116 and/or pivoting lid portion 118 of the container lid 104 defines a shaped opening 101 which is sized to allow a pet to pass readily through the shaped opening 101 into and out of the interior cavity 106 of the pet container 100.

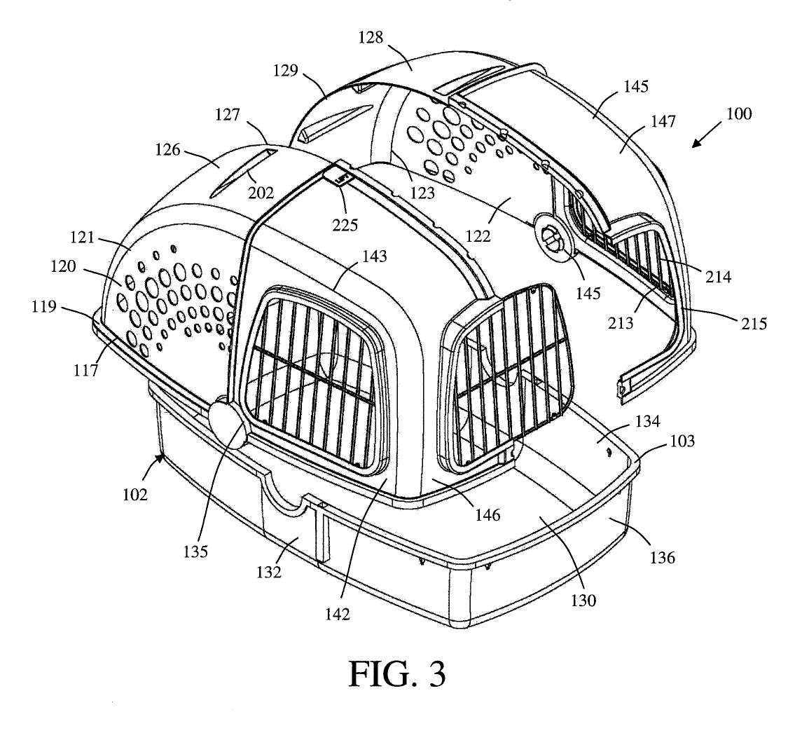

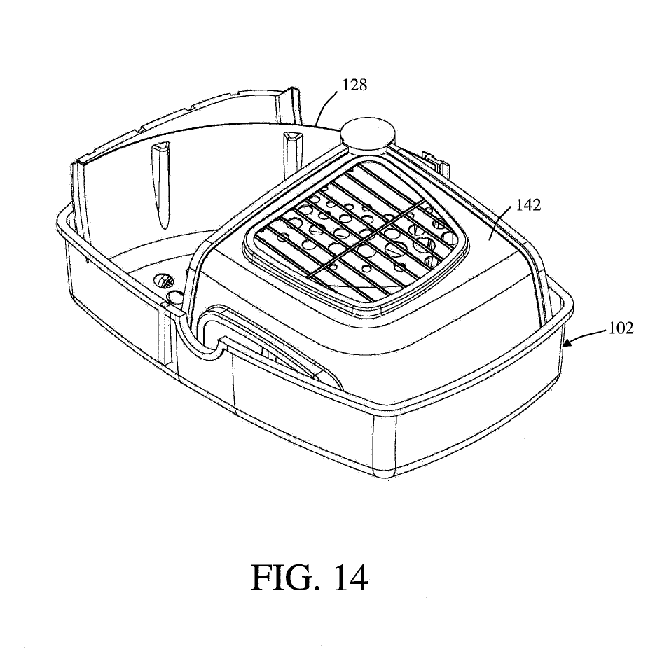

The stationary lid portion 116 of the container lid 104 is illustrated as further comprising parallel, spaced sidewalls 120, 122 having arcuate peripheral edges 121, 123, respectively. The stationary lid portion 116 of the container lid 104 is illustrated as further comprising a top wall 124 connected approximately perpendicularly (e.g., 85-95°) along the arcuate peripheral edges 121, 123 of the sidewalls 120, 122, respectively. As illustrated in FIG. 3, the stationary lid portion 116 can optionally be formed of two portions, namely a first top wall portion 126 and a second top wall portion 128. The first top wall portion 126 and the second top wall portion 128 are designed to be connectable. As best illustrated in FIG. 3, first top wall portion 126 is formed marginally continuous and approximately perpendicularly (e.g., 85-95°) with the arcuate peripheral edge 121 of sidewall 120, and second top wall portion 128 is formed marginally continuous and approximately perpendicularly (e.g., 85-95°) with the arcuate peripheral edge 123 of sidewall 122. As can be appreciated, the first top wall portion 126 and the second top wall portion 128 can have other configurations. The configuration of the first top wall portion 126 and the second top wall portion 128 in FIG. 3 provides the advantage in that when the pet container 100 is fully disassembled (see FIG. 14), the pet container 100 requires minimal amount of storage space.

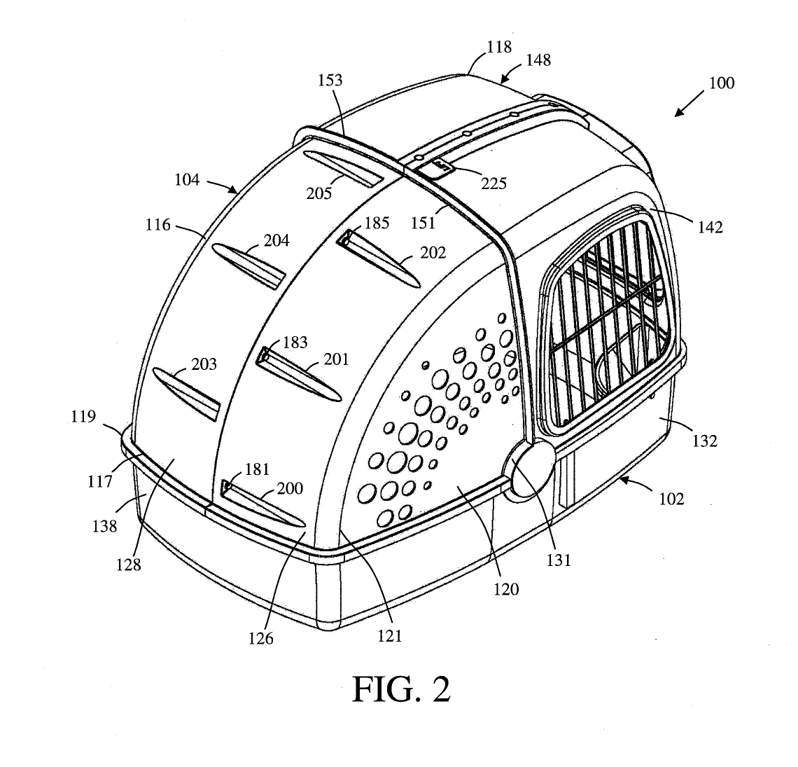

During assembly, the connection edge 127 of the first top wall portion 126 and the connection edge 129 of second top wall portion 128 of the stationary lid portion 116 can be releasably connected together by one or more screws and/or bolts. See, for example, screws and/or bolts 181, 183, 185 in FIG. 2. The stationary lid portion 116 can then be positionable on the container base 102 such that the coupling edge 117 of stationary lid portion 116 couples on coupling edge 103 of container base 102. The stationary lid portion 116 of container lid 104 can be releasable connected or permanently connected to the container base 102. The type of coupling arrangement is non-limiting. Such coupling arrangements can include a mechanical connection (e.g., screw, bolt and nut arrangement, pin connection, slot locking connection, etc.), adhesive, etc.

Generally, coupling edge 117 of stationary lid portion 116 corresponds in shape and size to the coupling edge 103 of the container base 102. The coupling edge 117 can include a coupling lip 119 around the perimeter of the coupling edge 117 of the stationary lid portion 116. The coupling lip 119 can be designed to fully engage with the coupling edge 103 of the container base 102.

The two sidewalls 120, 122 of stationary lid portion 116 of container lid 104 are illustrated as including a plurality of openings and/or apertures 140 such that fresh air can circulate through the interior cavity 106 of the pet container 100. The number, size, shape and location of the openings and/or apertures 140 on the stationary lid portion 116 is non-limiting. Generally, the size of the openings and/or apertures 140 on the stationary lid portion 116 are sized to inhibit or prevent an animal in the pet container 100 from passing through the openings and/or apertures 140.

As will be described in more detail later with reference to FIGS. 2-3, the two sidewalls 120, 122 of stationary lid portion 116 are illustrated as including pivot and/or connection arrangements 131, 133, respectively, to enable the container lid 104 to move relative to the stationary lid portion 116.

As best illustrated in FIG. 2, the stationary lid portion 116 of container lid 104 is illustrated as optionally including a plurality of ridges, grooves, or other type of surface structures on the external surface of the top wall 124. The external surface of the top wall 124 of stationary lid portion 116 is illustrated as including six grooves 200, 201, 202, 203, 204, 205. The six grooves, 200, 201, 202, 203, 204, 205 can be used as surface structures to facilitate the connection between the two top wall portions 126, 128 of stationary lid portion 116. For example, as best illustrated in FIG. 2, groove 200 can facilitate the connection of the first top wall portion 126 to the second top wall portion 128 via screw and/or bolt 181. Similarly, groove 201 can facilitate the connection of the first top wall portion 126 to the second top wall portion 128 via screw and/or bolt 183, and groove 202 can facilitate the connection of the first top wall portion 126 to the second top wall portion 128 via screw and/or bolt 185.

The container lid 104 is also illustrated as including a pivoting lid portion 118. The pivoting lid portion 118 of container lid 104 can include two parallel spaced sidewalls 142, 144, and a top wall 148. The top wall 148 is illustrated as further comprising a first top wall portion 146 connectable to a second top wall portion 147. The connection can be a releaseable or a permanent connection. The type of connection is not limiting (e.g., screw, adhesive, snap connection, pin connection, etc.). As best illustrated in FIG. 3, first top wall portion 146 is formed marginally continuous and approximately perpendicularly (e.g., 85-95°) with edge 143 of sidewall 142, and second top wall portion 147 is formed marginally continuous and approximately perpendicularly (e.g., 85-95°) with edge 145 of sidewall 144. As can be appreciated, the pivoting lid portion 118 can be formed of more than two pieces or formed or only a single piece.

The two sidewalls 142, 144 are spaced about equal to or greater than the width of the container base 102 such that, when the pivoting lid portion 118 is positioned on the container base 102, at least a portion of the pivoting lid portion 118 fits over the stationary lid portion 116; however, this is not required.

The two sidewalls 142, 144 of pivoting lid portion 118 are illustrated as including pivot and/or connection arrangements 135, 137, respectively. The pivot and/or connection arrangements 135, 135 of the pivoting lid portion 118 are designed to interact with the pivot and/or connection arrangements 131, 133 of the stationary lid portion 116; however, this is not required.

The pivoting lid portion 118 of container lid 104 is illustrated as being releasably and/or pivotally connected to: 1) the container base 102, and/or 2) the stationary lid portion 116 of container lid 104. Generally, the coupling edge 99 along the edges of the two sidewalls 142, 144 and the top wall 148 of pivoting lid portion 118 corresponds to the coupling edge 103 of the container base 102. The coupling edge 99 can optionally include a coupling lip 97 around the perimeter of the coupling edge 99 of pivoting lid portion 118. The coupling lip 97 is designed to fully engage with the coupling edge 103 of container base 102. Due to the configuration of the stationary lid portion 116 and pivoting lid portion 118, the width of the container base 102 is adjusted accordingly so that the coupling edge of the stationary lid portion 116 and pivoting lid portion 118 engages the coupling edge 103 of container base 102. As such, since the spacing of the sidewalls 142, 144 of pivoting lid portion 118 is greater than the spacing of the sidewalls 120, 122 of stationary lid portion 116 so that the pivoting lid portion 118 can move over the stationary lid portion 116 when the pivoting lid portion 118 is moved between the fully open and closed positions, the spacing of the coupling edge 103 of container base 102 on the sidewalls of the container base 102 for the pivoting lid portion 118 is greater than the spacing of the coupling edge 103 of container base 102 on the sidewalls of the container base 102 for the stationary lid portion 116. As can be appreciated, the reverse would be true if the pivoting lid portion 118 was alternatively configured to pivot inside the stationary lid portion 116.

The pivoting lid portion 118 of container lid 104 is also illustrated as including a plurality of openings and/or apertures such that fresh air can circulate through the interior cavity 106 of the pet container 100. As best illustrated in FIGS. 1-5, an opening 211, 213 is provided in each of the two sidewalls 142, 144, respectively. Additionally, an opening 215 is also illustrated as being provided in the front wall 146 of the pivoting lid portion 118. One or more grates, rods and/or bar structures 212, 214, 216 can optionally be provided within one or more of the openings 211, 213 215, respectively, for the purpose of inhibiting or preventing a pet from exiting the pet container 100 through the openings 211, 213, 215. The grate structures 212, 214, 216 are illustrated as being fixedly and/or rigidly connected 1) within each opening 211, 213 215 and/or 2) to the walls 142, 144, 146 of pivoting lid portion 118. As can be appreciated, the number, size, shape and location of the opening in the pivoting lid portion 118 is non-limiting. As can also be appreciated, one or more of the grate structures can optionally be openable.

The pivoting lid portion 118 is illustrated as being pivotally connected to 1) the container base 102, and/or 2) the stationary lid portion 116 of container lid 104.

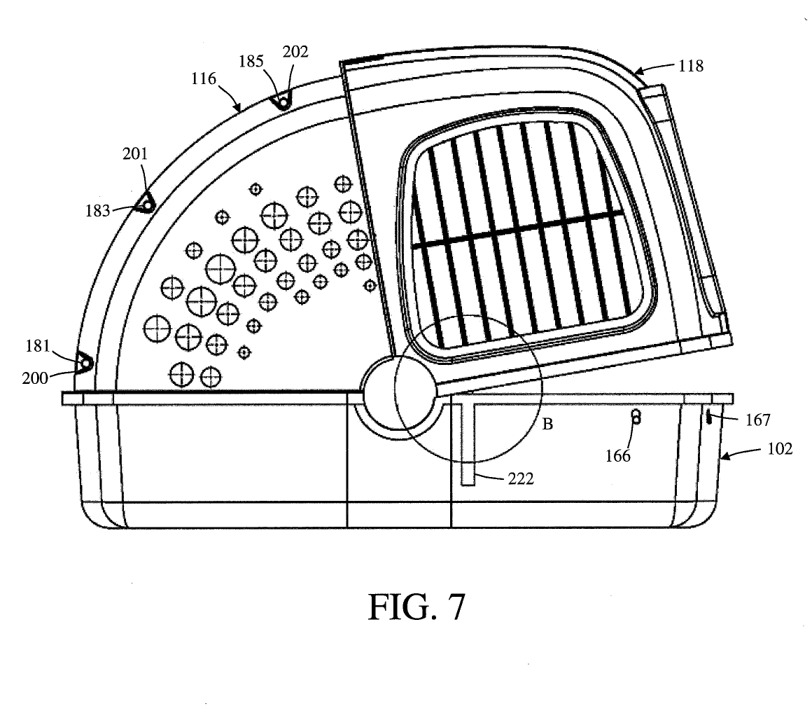

In operation, the pivoting lid portion 118 of container lid 104 is operable to move between a fully open and a fully closed position. The pivoting lid portion 118 pivots about a pivot axis “A” and sits over the stationary lid portion 116 of the container lid 104. The pivoting lid portion 118 of container lid 104 can be designed to remain fully closed (see FIG. 1), remain partially open (see FIG. 7), and/or remain fully open (see FIG. 4). In an open position: 1) an interior surface of sidewall 142 of pivoting lid portion 118 is adjacent to the external surface of sidewall 144 of stationary lid portion 116; 2) an interior surface of sidewall 144 of pivoting lid portion 118 is adjacent to the external surface of sidewall 146 of stationary lid portion 116; 3) the interior surface of front wall 146 of pivoting lid portion 118 is adjacent to the external surface of a top portion of the arcuate top wall 124 of stationary lid portion 116; and 4) the interior surface of the top wall 148 of pivoting lid portion 118 is adjacent to the external surface of the bottom portion of the arcuate top wall 124 of stationary lid portion 116. In an open position, a pet can freely enter and/or exit the interior cavity 106 of the pet container 100.

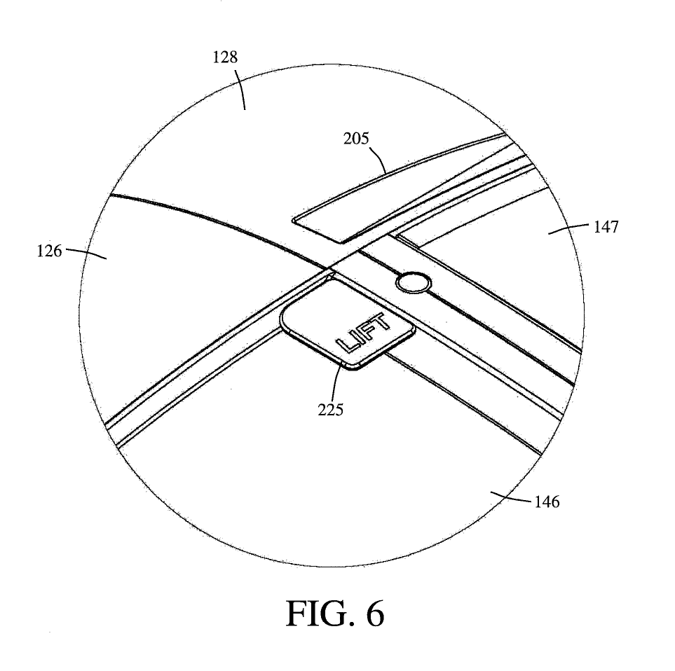

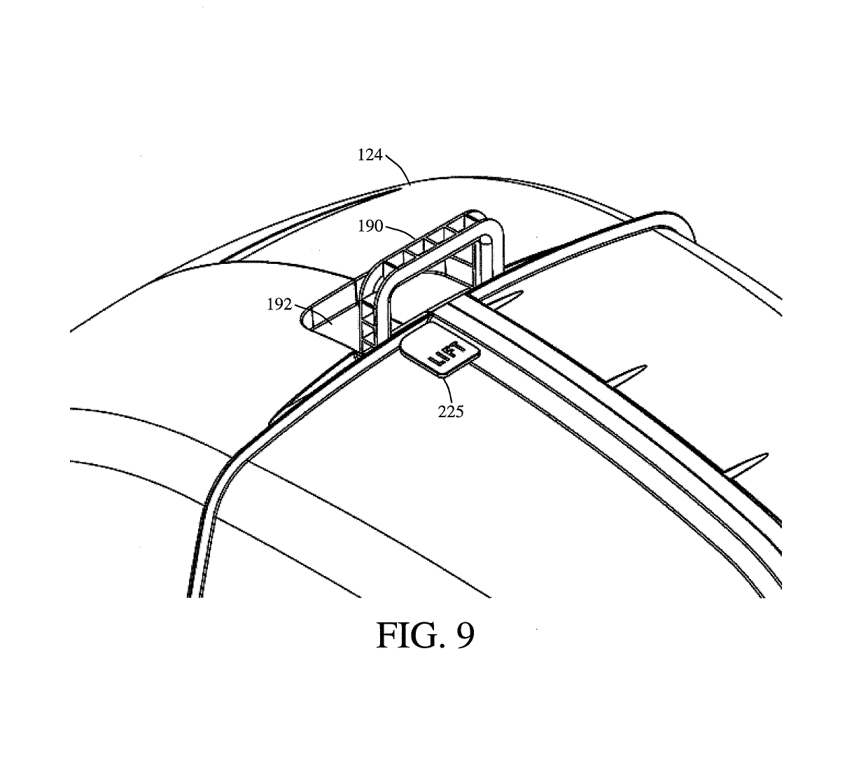

The container lid 104 of pet container 100 of the present invention is illustrated as including an opening actuator 225. The opening actuator 225 is optionally positioned at or near the rear edge 153 of the top wall 148 of the pivoting lid portion 118 of container lid 104. As best illustrated in FIGS. 6 and 9, opening actuator 225 is illustrated as being an ergonomic quick release tab. The opening actuator 225 is designed to frictionally engage with the front edge 151 of the stationary lid portion 116 when the pet container 100 is in a closed position, thereby preventing the pivoting lid portion 118 from pivoting and moving to an open position over the stationary lid portion 116. When the opening actuator 225 is lifted, a portion of the opening actuator 225 can be caused to raise upwards so as to disengage the frictional engagement between the opening actuator 225 and the front edge of the stationary lid portion 116. When the opening actuator 225 is in engagement with the front edge of the stationary lid portion 116, the pivoting lid portion 118 is generally in the fully closed and locked position.

The opening actuator 225 is illustrated as including “LIFT” on its surface; however, other and/or alternative information can be provided on the opening actuator 225. As can be appreciated, the opening actuator 225 can be biased in a closed position. Such biasing can be by a flexible material (e.g., plastic material) as illustrated in FIG. 1 and/or by a spring. The opening actuator 225 can include one or more structures or materials to increase the friction engagement (e.g., ribs, rough surface, rubber or elastomer material, etc.). Alternatively, the opening actuator 225 can be configured to engage one or more surface structures on the stationary lid portion 116; however, this is not required.

As best illustrated in FIGS. 4-5, the pet container can optionally include a first pet bowl 160 and/or a second pet bowl 162. As can be appreciated, more than two bet bowls can be used. The pet bowls 310, 312 are illustrated as being connectable and removable to the container base via one or more pins. For example, pet bowl 160 is illustrated as including two pins 164, 164 connectable to corresponding apertures 166, 167 of the container base, respectively. Pet bowl 162 is illustrated as including a pin 168 connectable to aperture 169 of container base 102. Furthermore, pet bowl 162 is illustrated as including a removable bowl 170 which can optionally be removed from the pet bowl 162. As such, the removable bowl 170 can be easily and conveniently removed, filled and replaced back to the removable bowl 170. As can be appreciated, other or additional connection arrangements can be used for one or more of the bowls. The one or more pet bowls are illustrated as being located at the front interior end of the container base. As can be appreciated, one or more pet bowls can be located in other locations of the container base. The top edge of the one or more bowls is illustrated as being position flush with or below the top edge of the container base when connected to the container base. The size and/or shape of two or more of the pet bowls can be the same or different.

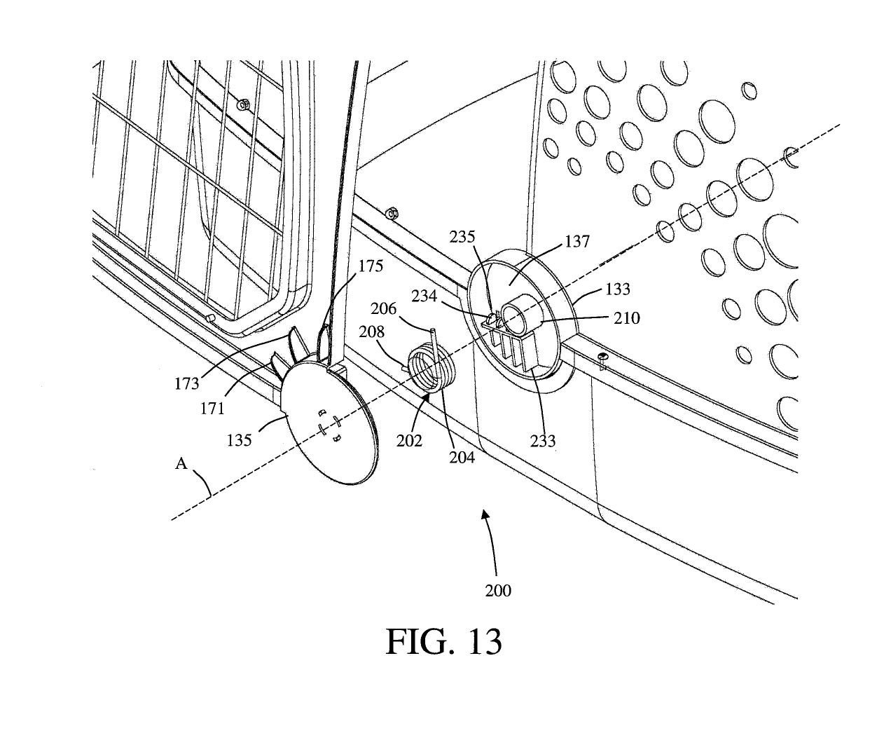

FIG. 13 is an exploded side-view perspective illustration of hinge assembly 200 that can optionally be used in the pet container 100 of FIG. 1. The pet container 100 includes a second hinge assembly 201 provided on a second side of the pet container 100 (see FIG. 4). Although only hinge assembly 200 will be described in further detail, it can be appreciated that the same description may apply to the second hinge assembly 301. Generally, the hinge assembly 200 is provided to facilitate movement of the container lid 104 to an open (FIG. 4) and/or closed (FIG. 1) position. Hinge assembly 200 is illustrated as including a mechanical spring 202 for the purpose of biasing the pivoting lid portion 118 in one of a variety of positions including a fully-closed, partially-closed, partially-open, and/or fully-open position. The mechanical spring 202 can optionally be used to bias the pivoting lid portion 118 of the container lid 104 in an open position. The mechanical spring 202 is illustrated as including a coiled portion 204, a first extension 206 and a second extension 208. With continued reference to FIG. 13, pivot and/or connection arrangement 133 is illustrated as including a mount 210 and a support structure 233 having a plurality of support members (one of which is marked as 234) which define a cavity 235. The number of support members is non-limiting. Generally, the mechanical spring 202 is connectable to the pivot and/or connection arrangement 133 such that the coiled portion 204 of mechanical spring 202 seats over the mount 210. Furthermore, the mechanical spring 202 is connectable to the pivot and/or connection arrangement 133 such that the second extension 208 of mechanical spring 202 seats at least partially in the cavity 137 formed when support member 135 and connection arrangement 133 are connected together. The pivot and/or connection arrangement 135 of pivoting lid portion 118 can then be connected to the pivot and/or connection arrangement 133 of stationary lid portion 116. In doing so, the first extension 206 of mechanical spring 202 can be adjusted so as to contact one of three surface structures 171, 173, 175 of pivot and/or connection arrangement 135. As can be appreciated, the number of surface structures is non-limiting (e.g., 1, 2, 3 . . . 20, etc.). Thus, the pivoting lid portion 118 can be biased in one or more positions via mechanical spring 202. As such, in operation, when the opening actuator 225 is actuated (i.e., causing the opening actuator to move to an unlocked position, etc.), the pivoting lid portion 118 of the container lid 104 springs back into an open position via mechanical spring 202, thereby allowing a pet to enter the interior cavity 106 of pet container 100. For example, when three surface structures are used, the surface structures in combination with the mechanical spring can cause the pivoting lid portion be biased such that the mechanical spring will cause the pivoting lid portion to rotate 30° about the axis A, rotate 60° about the axis A, or rotate 90° about the axis A. As can be appreciated, the spacing and/or number of the surface structures in combination with the type of mechanical spring can be used to cause the pivoting lid portion to be biased in any number of open positions (e.g., biased rotation of the pivoting lid at any position between 0-120°) when the opening actuator 225 is moved to the open or unlocked position. The pivoting lid portion can be removed from the stationary lid portion 116 to adjust the biasing position of the mechanical spring 202 as desired.

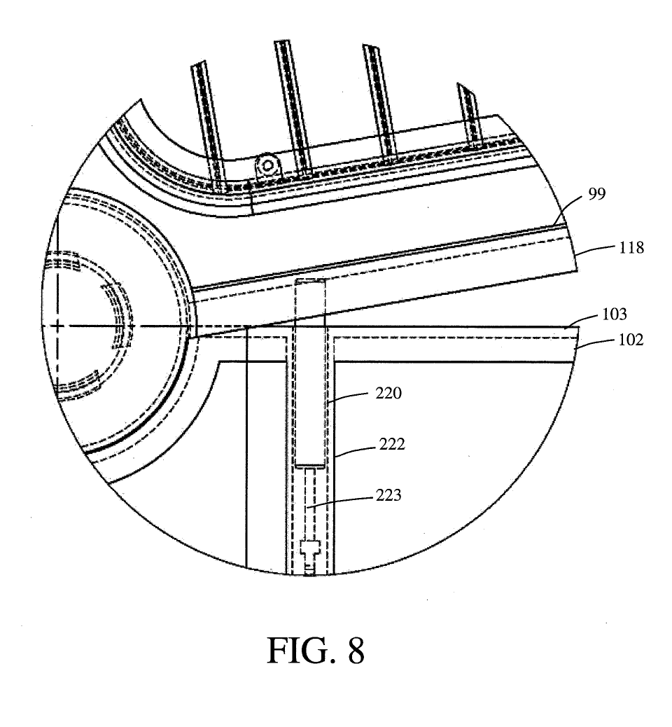

Referring now to FIGS. 7-8, the pet container 100 is illustrated as optionally including a mechanical strut 220. FIG. 8 is a zoomed-in view of the area B in FIG. 7. The mechanical strut 220 is generally provided so as to prevent the pivoting lid portion 118 of the container lid 104 from closing with excessive force. This may be particularly useful, for example, if a pet residing in the interior cavity 106 of the pet container 100 has its paws over the front wall 136 of container base 102 when the pivoting lid portion be being closed. The use of such a mechanical strut may prevent the pet's paws from being smashed between the coupling edge 99 of pivoting lid portion 118 and coupling edge 103 of container base 102. The mechanical strut 220 is illustrated as being mounted in a support bracket 222 of container base 102. The mechanical strut is configured to move up and down within the cavity of the support bracket 222. As best illustrated in FIG. 8, the mechanical strut 220 can be biased by a biasing arrangement 223 (e.g., mechanical spring, gas spring, etc.) so as to push the pivoting lid portion 118 upwardly from container base 102 and to prevent the pivoting lid portion 118 of the container lid 104 from closing with excessive force. The mechanical strut can also to alternatively be used to facilitate in the moving of the pivoting lid portion from the fully closed position to an open position when the opening actuator 225 is moved to an open or unlatched or unlocked position; however, this is not required. When the pivoting lid portion is in the fully open position, the top end of the mechanical strut extends above a top surface of said container base 102 as illustrate in FIG. 8. Generally, the mechanical strut is configured to cause the pivoting lid portion to move only partially to the fully open position (e.g., move 5-80% to the fully open position and all values and ranges therebetween). The hinge assembly 200, 201 are generally configured to bias the pivoting lid portion to a greater open position than caused by the mechanical strut. As such, the hinge assembly generally causes the pivoting lid portion to be lifted off of the end of the mechanical strut as the hinge assembly moves the pivoting lid portion to the biased open position; however, this is not required. As such, when the pivoting lid portion first begins to move from the fully closed position to an open position, the biasing from both the mechanical strut and the hinge assembly cause the pivoting lid portion to move to an open position. Thereafter, the hinge assembly causes the pivoting lid portion to continue moving to an open position after the point wherein the pivoting lid portion lifts off of the end of the mechanical strut. As can be appreciated, the mechanical strut can be configured to engage the pivoting lid portion at all times as the pivoting lid portion moves between the fully closed and fully open positions; however, this is not required.

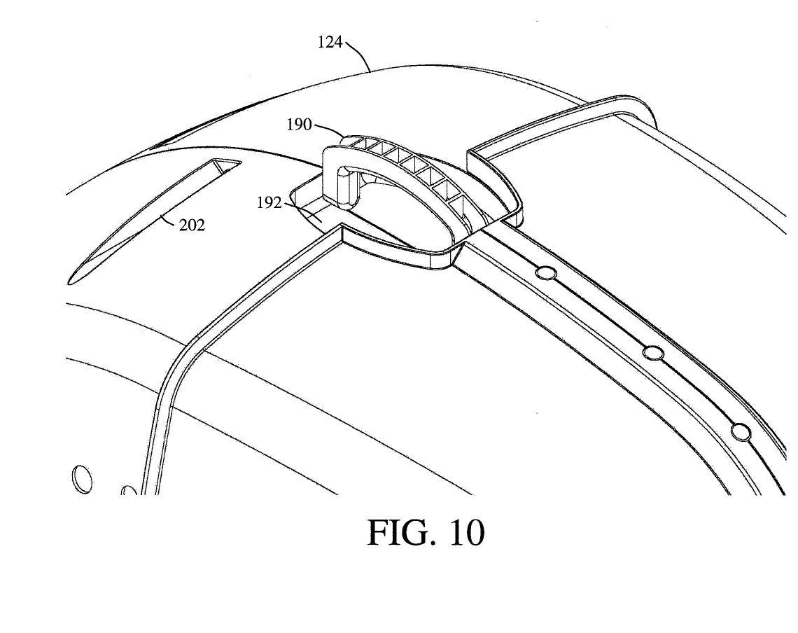

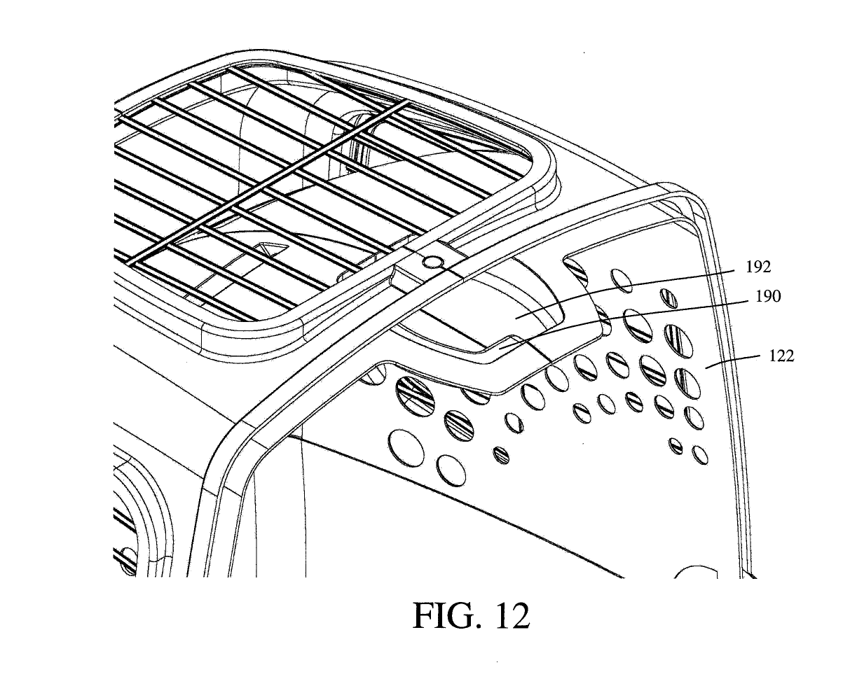

As best illustrated in FIGS. 9-12, the container lid 104 optionally includes a handle 190. Generally, the handle 190 is connected to the container lid 104 of the pet container 100 for the purpose of facilitating movement of the pet container 100. The profile of the handle 190 is generally selected to be a low profile so as to enable the handle 190 to be tucked away and/or hidden when the container lid 104 is in the open position. The handle 190 is generally configured to be pivotally connected to the container lid 104; however, this is not required. As illustrated in FIGS. 9-12, the handle 190 is pivotally connected to the top wall 124 of the stationary lid portion 116 of the container lid 104. As best illustrated in FIG. 9-10, in a tucked away position (i.e., as the pivoting lid portion 118 of the container lid 104 is rotated over the stationary lid portion 116 of the container lid 104), the handle 190 is moved into a cavity or recess 192 formed in the top wall 124 of the stationary lid portion 116 of container lid 104. Generally, the handle is positioned flush with or below the upper surface of the container lid when moved to the stowed position as illustrated in FIG. 12. In such a configuration, the pivoting lid portion 118 of the container lid 104 can be freely rotated and moved over the handle when the pivoting lid portion is moved between an open and closed position without physical interference by the handle 190. As illustrated in FIGS. 9 and 10, the handle can be optionally configured such that when the handle is in the raised position, the handle can function as a stop to prevent the pivoting lid portion from moving to an open position that would enable a pet in the pet container to escape the pet container; however, this is not required.

In operation, the pet container 100 can be used as a pet kennel or pet cage. A pet owner can place a pet into the pet container by: 1) actuating the opening actuator 225 (e.g., lifting the opening actuator), thereby allowing the pivoting lid portion 118 of the container lid 104 to rotate about a pivot axis “A” to a partially or fully open position; 2) placing the pet into or allowing the pet to enter the interior cavity 106 of the pet container 100; 3) pushing down the pivoting lid portion 118 of the container lid 104 such that the pivoting lid portion 118 rotates back down to the closed position; and/or 4) continuing to push the pivoting lid portion 118 down, thereby allowing the opening actuator 225 to engage the front edge of the stationary lid portion 116 to fully close and lock the pivoting lid portion in the fully closed position.

In operation, the pet container 100 can also be used as a trainer to encourage a pet to use the pet container 100 as a pet cage and/or pet kennel. The method can comprise the steps of: 1) providing the pet with the container base 102 without the container lid 104 such that the pet trusts and finds comfort in the container base 102 in a fully open position (i.e., an opening of about) 90°. Alternatively, the training can begin with the pivoting lid portion 118 of the container lid in an open or fully open position. If the pet training is begun without the pivoting lid, then step two is positioning the pivoting lid portion on the pet container and having the pivoting lid portion positioned in an open or fully open position. Once the pet is use to the pivoting lid portion positioned in an open or fully open position, the pivoting lid portion can be slightly lowered toward the fully closed position and allowing time for the pet to trust and find comfort in the pet container 100 while the pivoting lid portion 118 of the container lid 104 is in the slightly more closed position. The pivoting lid portion can be continued to be moved to the fully closed position so that the pet gets use to being in the pet container while in the fully closed position. As such, over time, the pivoting lid portion 118 of the container lid 104 can be incrementally lowered towards a closed position based on the speed of training and acceptance of the pet to the pet container. Once the pet is used to the pivoting lid portion being in the fully closed position, the pet can be optionally trained to enter and exit an opening in the pivoting lid open (e.g., opening a grate structure, etc.).

When such a method is used, the pet can feel more comfortable with being inside the pet container 100 as the container lid 104 is gradually lowered. The amount of bias opening of the pivoting lid portion 118 can be set by adjusting the mechanical spring 202 (e.g., 30° rotation, 60° rotation, 90° rotation, etc.) when the opening actuator 225 is moved to the open position. As such, if the mechanical spring 202 is adjusted to cause the pivoting lid portion to rotate 30° when the opening actuator 225 is moved to the open position, the mechanical spring will cause the pivoting lid portion to rotate 30° about the axis A, thus causing the pivoting lid portion to move from a fully closed position to a partially open position. Thereafter, the pivoting lid portion can be manually caused to open further or be moved to a closed or fully closed position. As illustrated in FIGS. 1-8, the fully open position is generally equal to a 90° rotation about axis A from the fully closed position.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawing shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A pet container, the pet container comprising:
a container base, said container base comprising a base wall and a sidewall;
a container lid positionable on said container base to form an interior cavity, said container lid including stationary lid portion and a pivoting lid portion;
wherein said pivoting lid portion is rotatable relative to said stationary lid portion between a fully open position and a fully closed position when said container lid is connected to said container base, said stationary lid portion non-rotatabley connected to said container base and stationary relative to said pivoting lid portion when said pivoting lid portion is moved between said fully open position and fully closed position; and,
wherein a pet can access said interior cavity of said pet container when said pivoting lid portion is rotated to an open position.

2. The pet container as defined in claim 1, wherein said stationary lid portion includes a top wall and two sidewalls; and, said pivoting lid portion includes a top wall and two sidewalls.

3. The pet container as defined in claim 2, wherein said stationary lid portion includes a first top wall portion releasably connectable to a second top wall portion, and said pivoting lid portion includes a first top wall portion releasably connectable to a second top wall portion.

4. The pet container as defined in claim 1, wherein said container lid is releasably connected to said container base.

5. The pet container as defined in claim 1, wherein said container lid includes an opening actuator configured to releasably lock said pivoting lid portion in a closed position.

6. The pet container as defined in claim 1, further comprising a hinge assembly, said hinge assembly including a biasing arrangement to bias said pivoting lid portion in an open position.

7. The pet container as defined in claim 6, wherein said hinge assembly includes at least one surface structure used to adjust a degree of biasing of said pivoting lid portion.

8. The pet container as defined in claim 7, wherein said hinge assembly includes a plurality of surface structures, each of said surface structures used to adjust a degree of biasing of said pivoting lid portion, said hinge assembly including a mechanical spring that interacts with one of said surface structure to cause said biasing of said pivoting lid portion.

9. The pet container as defined in of claim 1, wherein the stationary lid portion and said pivoting lid portion both include a plurality of apertures to allow fresh air to circulated through said interior cavity of said pet container.

10. The pet container as defined in claim 1, wherein said container base includes a biasing strut that interacts with said pivoting lid portion to bias said pivoting lid portion to an open position when said pivoting lid portion is in a fully closed position.

11. The pet container as defined in claim 1, wherein said stationary lid portion includes a handle recess and a handle that is connected in said handle recess, said handle is rotatably connected to the stationary lid portion so as to be rotated between an upright position and a tucked away position in said handle recess.

12. A method for using a pet container, the method comprising:
providing a pet container, said pet container comprising a container base, said container base comprising a base wall and a sidewall; a container lid positionable on said container base to form an interior cavity, said container lid including stationary lid portion and a pivoting lid portion; an opening actuator and hinge assembly configured to enable said pivoting lid portion to move about a pivoting axis from a fully closed position to an open position when said opening actuator is actuated; wherein said pivoting lid portion is rotatable relative to said stationary lid portion between a fully open position and said fully closed position when said container lid is connected to said container base, said stationary lid portion non-rotatabley connected to said container base and stationary relative to said pivoting lid portion when said pivoting lid portion is moved between said fully open position and fully closed position; and, wherein a pet can access said interior cavity of said pet container when said pivoting lid portion is rotated to said open position;
actuating said opening actuator to unlock said pivoting lid portion from said fully closed position;
moving said pivoting lid portion from said fully closed position to said open position to enable a pet to access said interior cavity of said pet container.

13. The method as defined in claim 12, including the further steps of moving said pivoting lid portion from said open position to said fully closed position until said opening actuator locks said pivoting lid portion in said fully closed position.

14. The method as defined in claim 12, wherein said stationary lid portion includes a first top wall portion releasably connectable to a second top wall portion, and said pivoting lid portion includes a first top wall portion releasably connectable to a second top wall portion.

15. The method as defined in claim 12, wherein said hinge assembly includes a biasing arrangement to bias said pivoting lid portion in an open position.

16. The method as defined in claim 15, wherein said hinge assembly includes one or more surface structures, each of said surface structures used to adjust a degree of biasing of said pivoting lid portion, said hinge assembly including a mechanical spring that interacts with one of said surface structure to cause said biasing of said pivoting lid portion.

17. The method as defined in claim 12, wherein said container base includes a biasing strut that interacts with said pivoting lid portion to bias said pivoting lid portion to an open position when said pivoting lid portion is in a fully closed position.

18. The method as defined in claim 12, wherein said stationary lid portion includes a handle recess and a handle that is connected in said handle recess, said handle is rotatably connected to the stationary lid portion so as to be rotated between an upright position and a tucked away position in said handle recess.

19. A method for using a pet container to train a pet to use the pet container, the method comprising:
providing a pet container, said pet container comprising a container base, said container base comprising a base wall and a sidewall; a container lid positionable on said container base to form an interior cavity, said container lid including stationary lid portion and a pivoting lid portion; wherein said pivoting lid portion is rotatable relative to said stationary lid portion between a fully open position and a fully closed position when said container lid is connected to said container base, said stationary lid portion non-rotatabley connected to said container base and stationary relative to said pivoting lid portion when said pivoting lid portion is moved between said fully open position and fully closed position; and, wherein a pet can access said interior cavity of said pet container when said pivoting lid portion is rotated to an open position;
positioning said pivoting lid portion in an open position;
allowing time for a pet to adjust to staying in said pet container while said pivoting lid portion in a first open position; and, lowering said pivoting lid portion to said fully closed position and allowing time for a pet to adjust to staying in said pet container while said pivoting lid portion in said fully closed position.

20. The method as defined in claim 19, further comprising the step of lowering said pivoting lid portion from said first open position to a second open position and allowing time for a pet to adjust to staying in said pet container while said pivoting lid portion in said second open position.
